(19) United States
(12) Patent Application Publication
(10) Pub. No.: US 2026/0024016 A1
(43) Pub. Date: Jan. 22, 2026

(54) AI Agent and Methods of Using Same

(71) Applicant: Randy Alan Andrews, Keller, TX (US)

(72) Inventor: Randy Alan Andrews, Keller, TX (US)

(21) Appl. No.: 19/029,398

(22) Filed: Jan. 17, 2025

Related U.S. Application Data
(60) Provisional application No. 63/621,886, filed on Jan. 17, 2024.

(51) Int. Cl. G06N 20/00

(52) U.S. Cl. CPC G06N 20/00

(57) ABSTRACT

An artificial intelligence (AI) agent. The agent comprising a computing device comprising at least one processor, said at least one processor programmed with computer program instructions that, when executed by said processor, the computer program instructions program said computing device to monitor a first user behavior; monitor the first user input; aggregate data from users other than the first user; and utilize Artificial Intelligence (AI) to continuously learn from user behavior, user input, and aggregated data from other users other than the first user.

### PRIORITY CLAIM

This application claims the benefit of U.S. Provisional Application No. 63/621,886 filed on January 17, 2024. the entirety of which is incorporated herein by reference.

### FIELD

The present disclosure relates generally to a doppelganger AI agent. More particularly, the present disclosure relates to doppelganger AI agent or a digital twin, such as a software application that creates a virtual replica of an individual or an entity.

This digital counterpart can mimic behaviors, decisions, or operational processes of its real-world counterpart by using data like personal habits, preferences, or business metrics. A primary goal is to simulate scenarios, predict outcomes, or automate decision-making, thereby enhancing efficiency, personalizing experiences, or aiding in strategic planning. Essentially, it allows for real time interaction, learning, and adaptation, offering insights or actions that would otherwise require direct human intervention.

### BACKGROUND

In the rapidly evolving landscape of personal technology, there arises a need for devices that not only assist but also autonomously act on behalf of their users., integrating into daily life with minimal human intervention. The present disclosure of an AI agent doppelganger mobile device represents a significant leap towards this reality, designed to serve as a digital extension of digital “twin” of the user.

In one arrangement, this device utilizes one or more artificial intelligence algorithms to mimic, learn, from and anticipate the user's behaviors, preferences, and communication styles. By doing so, the AI agent can autonomously manage a wide array of personal and professional tasks, from the mundane to the complex, without direct oversight.

At its core, the AI agent doppelganger device is engineered to perform tasks such as scheduling appointments, managing communications, and even engaging in social interactions. It goes beyond simple automation by learning from user interactions, thereby enabling the AI agent to make decisions that align with the user's lifestyle, ethical standards, and/or professional conduct.

For example, in one arrangement, the AI agent can draft emails or messages in the user's own voice, manage a calendar by rescheduling based on perceived priorities or conflicts, or even participate in virtual meetings, responding appropriately to queries or discussions as if the user was present. This capability not only frees up significant time for the user but also ensures continuity and consistency in their person and professional engagements.

Further, in one arrangement, the AI device may be equipped with natural language processing capabilities allowing it to understand and generate human like text and speech, which can be important in scenarios where the user might be indisposed or unavailable yet needs to maintain active communication or social presence. Additionally, the AI agent can learn from various data inputs, including but not limited to, the user's digital footprint, calendar, email habits, and even voice patterns, to tailor its actions more precisely to the user's unique persona.

### SUMMARY

According to an exemplary arrangement, an artificial intelligence (AI) agent, said agent comprising a computing device comprising at least one processor, said at least one processor programmed with computer program instructions that, when executed by said processor, the computer program instructions program said computing device to monitor a first user behavior; monitor the first user input; aggregate data from users other than the first user; and utilize Artificial Intelligence (AI) to continuously learn from user behavior, user input, and aggregated data from other users other than the first user.

In one arrangement, the computing device comprises a smart phone.

In one arrangement, the computing program instructions comprise a mobile application.

In one arrangement, the computing device comprises a wearable technology.

In one arrangement, the wearable technology comprises a fitness tracker.

In one arrangement, the wearable technology comprises a biologic sensor.

In one arrangement, the wearable technology provides at least one human computer interface input.

In one arrangement, the at least one human computer interface input comprises a gesture recognition.

In one arrangement, the computer device is programmed to track personal user statistics.

In one arrangement, the computer device is programmed to track a personal behavior.

In one arrangement, the AI continuously learns from user input, such as an automatic input.

In one arrangement, the automatic input is selected from the group of speech input, text input, web browsing activities, facial image recognition, facial emotion detection, public data collection, purchase tracking, location and time tracking.

In one arrangement, the AI continuously learns from user input, such as manual input.

In one arrangement, the manual input comprises at least one written question.

In one arrangement, data is stored on the computing device.

In one arrangement, data is stored on a remote secured location.

In one arrangement, the remote secured location comprises a cloud server.

In one arrangement, the AI comprises a knowledge-based AI.

In one arrangement, when executed by said processor, the computer program instructions program said computing device to modify the AI agent by combining it with other known behavioral traits with different weights.

In one arrangement, when executed by said processor, the computer program instructions program said computing device to combine the AI agent with other users' agents with consent to make a combined agent copy.

In one arrangement, when executed by said processor, the computer program instructions program said computing device to monitor different user inputs and provide an appropriate health feedback and/or warning.

In one arrangement, when executed by said processor, the computer program instructions program said computing device, the agent diagnoses a person with psychological challenges and aids a user with strategies and/or solutions on how to best manage these psychological challenges.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a block diagram of the various components of a computing architecture for use with an AI module, such as the AI agent embodiments and methods disclosed and described herein; and

FIG. 2 illustrates a flow diagram illustrating a method for data collection to train an AI module, such as the AI agent embodiments and methods disclosed and described herein.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A general aim of the present disclosure is to provide methods and systems that allow for an AI agent that would accurately mimic the user in his/her own thinking style, decision making, and behavior.

In one arrangement, the AI agent would be installed on a user's smart phone as an application and would monitor user behavior and user manual input to continuously learn from the user behavior using Deep Learning. This would enable the agent to continuously improve its accuracy over time.

In yet another arrangement, the AI agent would learn from the aggregated data of all of the users in the world in order to more accurately train the individual model in order to better understand human thinking and decision making.

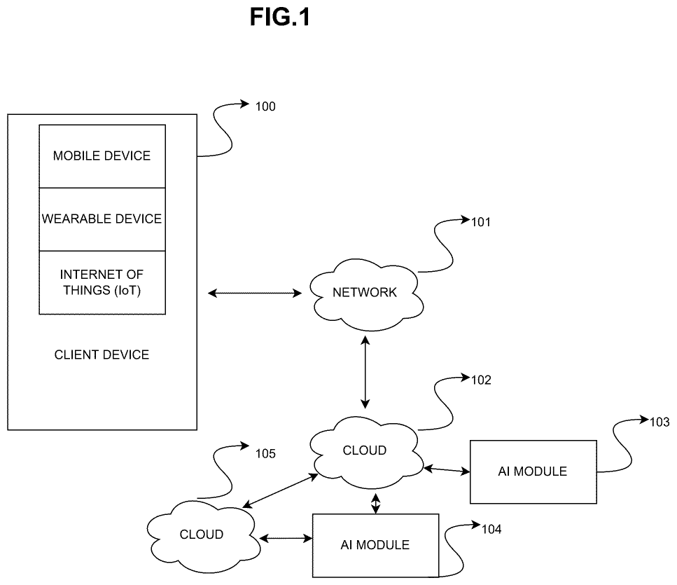

For example, FIG. 1 illustrates a block diagram of various components of an exemplary computing architecture for use with an AI module, such as the AI agent embodiments and methods disclosed and described herein.

Referring to FIG. 1, this computing architecture comprises a client computing device 100. In this illustrated arrangement, the client computing device 100 may comprise a mobile device. For example, such as a mobile device such as a smartphone or tablet, may comprise a compact, portable electronic device that is designed for mobile computing, communication and/or entertainment. These device typically feature touchscreens, wireless connectivity options like Wi-Fi and cellular data, and run on operating systems that can be optimized for mobility, such as iOS or Android, thereby enabling users to access the internet, use mobile applications (such as the presently disclosed AI agent), and manage personal information on the go. They integrate functionalities like calling, messaging, photography, navigation, and social media, all contained within a single, battery-powered unit that can fit in a pocket or small bag.

In one preferred arrangement, the client computing device 100 may comprise a wearable device. As an example, wearable technology are smart electronic devices that are worn close to and/or on the surface of the skin, where they detect, analyze, and transmit information concerning body signals such as vital signs, and/or ambient data. Examples include fitness trackers that are on the user's body and that are both passively and actively interacted with.

In one preferred arrangement, the client computing device 100 may comprise an internet of things (IoT) device. For example, an Internet of Things (IoT) device comprises an object or machine embedded with sensors, software, and/or network connectivity, allowing the device to exchange data with other devices and systems over a communications medium, like the internet. These devices range from everyday household items like smart thermostats and light bulbs to industrial sensors and wearable fitness trackers, all designed to collect, send, and act on data autonomously or in response to commands. IoT devices enhance automation, improve efficiency, and enable new forms of interaction between the physical world and computer-based systems by leveraging cloud computing, big data, and machine learning technologies.

Returning to FIG. 1, This client computing device 100 is operably coupled to a computer network 101. This operably coupling may comprise a wired or wireless connection. For example, the client device 100, such as a smartphone, laptop, or IoT sensor, is operably coupled to a computer network through either wired or wireless means. For wired connections, a client device may use an Ethernet cable plugged into a network interface card (NIC), which then communicates with a router or switch to access the network 101. In wireless scenarios, the client device 100 may connect via technologies like Wi-Fi or cellular data, where the client device 100 communicates with a wireless access point or directly with a base station, respectively, to establish a network link. Once connected, the client device 100 can send and receive data, access shared resources, and interact with other devices or services on the computer network 101, all managed by network protocols like TCP/IP.

And this computer network 101 is operably coupled to a cloud computing module 102. For example, the computer network 101 may be operably coupled to a cloud computing module 102 through a series of network interfaces and protocols designed to facilitate seamless data exchange. In one preferred arrangement, the computer network 101 connects to the internet via a gateway device, such as a router, which provides a secure and managed pathway to external networks. From there, the data traverses through internet service providers (ISPs) via various network backbones until it reaches the cloud computing module 102. As just one example, such a cloud computing module 102 may be hosted in data centers by companies like Amazon Web Services, Microsoft Azure, or

Google Cloud. The connection is often secured using protocols like SSL/TLS for data encryption, ensuring that information transferred between the computer network 101 and the cloud module 102 remains confidential and intact. This coupling allows network 101 to leverage the vast computational resources, storage, and services provided by cloud module 102, enabling functionalities like data storage, processing, and application hosting on demand.

And this cloud computing module 102 is operably coupled to a cloud based or network accessible artificial intelligence (AI) module 103. In one arrangement, this AI module 103 is configured as a single AI Module. In an alternative arrangement, this AI module 103 comprises a plurality of AI Modules.

In FIG. 1, artificial intelligence modules 104 represent AI modules that are separate and distinct from the users AI Modules. In addition, the AI modules 104 and cloud 102 are operably coupled to distributed cloud storage 105.

For example, in one arrangement, the distributed cloud storage 105 comprises a system where data is stored across multiple, geographically dispersed servers rather than on a single centralized server. This approach utilizes the principles of cloud computing but extends them by employing a network of interconnected data centers or nodes that might be managed by different providers or even by the users themselves. In one data communications arrangement, data is fragmented into pieces, encrypted, and then distributed across these nodes. Such a communications arrangement can help in enhancing data security, availability, and reducing latency by bringing data closer to the user or the point of consumption. This method not only mitigates risks associated with data loss due to server failures but also supports scalability as storage capacity can be increased by adding more nodes to the network. Additionally, distributed cloud storage can leverage blockchain technology for further security, ensuring data integrity and providing a transparent, tamper-resistant ledger of data transactions.

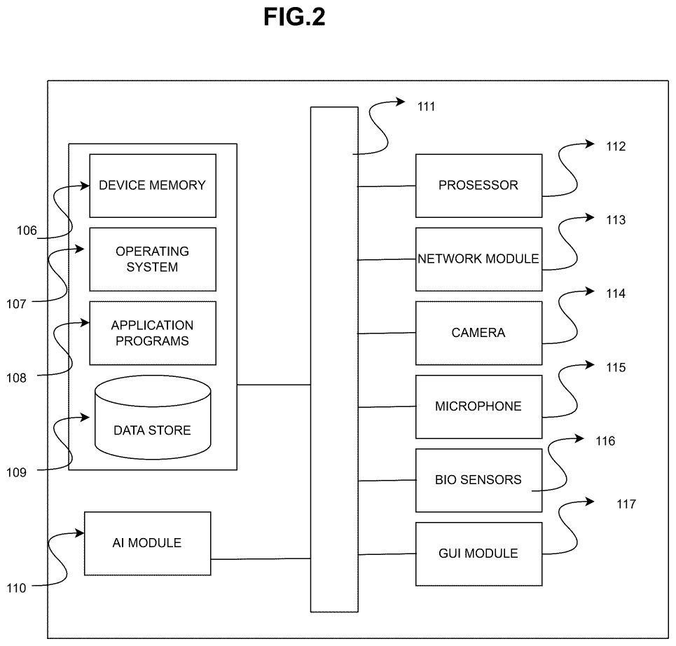

FIG. 2 illustrates a flow diagram illustrating a method for data collection to train an AI agent, such as the AI agent embodiments and methods disclosed and described herein. As illustrated in FIG. 2, the method includes utilizing device memory 106. As just one example, the device memory may comprise any computer-readable storage media readable by the processor.

In addition, the method utilizes an operating system 107. The operating system (OS) comprises the software that manages all the hardware and software resources of a computing device, providing a platform for applications to run and for users to interact with the device. As just one example, on a smartphone, the OS may be configured to handle critical tasks like managing memory, processing power, and facilitating communication between the hardware components and the apps. It controls the user interface, allowing interaction through touch, voice, or other inputs, and manages security features like app permissions and data encryption. Examples of mobile operating systems that may be utilized with the presently disclosed systems, apparatus, and methods include Android by Google and iOS by Apple, each offering a unique ecosystem of apps, services, and user experiences optimized for mobile use. However, as those of ordinary skill in the art will recognize, alternative operating system configurations may be utilized as well.

The method further utilizes application programs and software 108. Different types of application programs and/or software may be utilized. As just one example, on a smartphone, application programs or apps comprise software designed to perform specific tasks or provide particular services, enhancing the functionality of the device. Common apps include social media platforms, allowing users to connect, share, and communicate with others. Productivity apps enable users to work on documents, spreadsheets, and presentations on the go. Entertainment apps for music streaming or video content offer libraries for leisure and relaxation. Additionally, utility apps, like weather forecasts, navigation (e.g., Google Maps), and health trackers, provide practical daily assistance, tailoring the smartphone to fit individual needs and lifestyles.

The illustrated method further utilizes a database 109. As described in detail herein, various types of database and storage structures may be utilized.

In one preferred arrangement, the illustrated method further utilizes a local artificial intelligence module 110. For example, the Artificial Intelligence (AI) module in a mobile computing device, like a smartphone, comprises a component of the software that leverages machine learning algorithms, natural language processing, and other AI techniques to enhance user interaction and device functionality. As described in detail herein, various types of machine learning algorithms, natural language processing, and AI techniques may be utilized with the as disclosed and described AI agents.

For example, this AI module 110 can enable features like voice recognition for virtual assistants (e.g., Siri, Google Assistant), which can interpret and respond to user commands, perform tasks, or answer queries. The AI module 110 can also power intelligent automation, such as predicting text input, customizing user experiences through machine learning by analyzing usage patterns to suggest apps, news, or content.

In addition, the AI module 110 can be important for advanced photography features like scene recognition, which adjusts camera settings automatically for optimal image quality, or facial recognition for security authentication. Furthermore, the AI module can facilitate on-device AI processing for privacy-preserving tasks, reducing reliance on cloud services for data analysis while still providing sophisticated functionalities.

The method illustrated in FIG. 2 also, in one preferred arrangement, utilizes a communication channel 111. The communications channel 111 serves as the conduit for data exchange between an AI module 110 and various hardware components like a network module 113, the processor 112, the camera 114, the microphone 115, the bio sensor 116, and the GUI module 117. As just one example, the AI module 110 may use this communication channel 111 to send commands to the camera 114 or microphone 115 to capture media based on user requests or context awareness, processing the data to perform tasks like photo enhancement or voice command interpretation. Similarly, the AI module 110 can interface with the network module 113 to send and receive data over the internet, for instance, uploading images to cloud storage or downloading AI model updates.

When interacting with a bio sensor 116, the AI module 110 might use the communication channel 111 to gather health data, analyze it for real-time health insights or alerts, enhancing the device's capability to offer personalized health monitoring or adjustments to the user experience based on biometric feedback.

As just one example, in one preferred arrangement, the communication channel 111 may be configured as a single communication channel. In one alternative arrangement, the communication channel 111 may be configured as a plurality of communication channels

The method further utilizes a computer processor 112. In a mobile computing device, for example, the computer processor 112 can serve as a hub for communication between various hardware components and software modules, including an AI module 110. When the AI module 110 needs to interact with a network module 113 to send data over the internet, the processor 112 coordinates this by managing data packets, ensuring they are formatted correctly and routed through the appropriate network protocols. As another examples, for interfacing with the camera 114, the microphone 115, or the bio sensor 116, the processor 112 collects data from these sensors, processes it (like applying AI algorithms for image or voice recognition), and then either uses it locally or sends it to the AI module 110 for further analysis or action. This orchestration allows the AI module 110 to enhance functionalities like voice commands, facial recognition, or health monitoring by seamlessly integrating sensory data with network capabilities, all processed through the computational power of the smartphone's processor.

As also illustrated in FIG. 2, the method further utilizes a network module 113. For example, the network module 113 may enable communication between one or more devices. In a non-limiting way, a network module 113 may enable communication between a computing device, remote servers such as cloud computing module 102 and AI Modules 104, and with one or more devices.

In this illustrated arrangement, the method further utilizes a camera module 114. Camera module enables video/image produced or captured to be used by the AI modules such as AI module 103, AI module 104 and AI module 110 for training of the AI.

The method further utilizes a microphone module 115. For example, microphone module 115 may be configured to enable audio produced or captured to be used by the AI modules such as AI module 103 (FIG. 1), AI module 104 and AI module 110 for training of the AI.

The method further utilizes biometric module 116. For example, biometric module 116 may enable bio and health data produced or captured to be used by the AI modules such as AI module 103 (FIG. 1), AI module 104 and AI module 110 for training of the AI.

The method further utilizes a graphical user interface (GUI) module 117. For example, the GUI module 117 may be configured to enable a user to view the operation of, interact with and apply settings for the computer operating system and software such as AI module 103 (FIG. 1), the operating system 107 and the AI module 110.

### Plurality of Users

High accuracy individual and aggregate models would require data from a plurality of users. This data would need to be easily inputted or provided by the users. In one preferred arrangement, this is achievable though mobile applications on smart phones and current wearable technology. Wearable technology are smart electronic devices that are worn close to and/or on the surface of the skin, where they detect, analyze, and transmit information concerning body signals such as vital signs, and/or ambient data. Examples include fitness trackers that are on the user's body and that are both passively and actively interacted with.

In another arrangement, wearable technologies such as, but not limited to biologic sensors, such as the bio sensors 116 illustrated in FIG. 2 and Augmented Reality (AR) smart glasses would greatly increase the amount of user data available.

As just one example, in one preferred arrangement, AR smart glasses would provide useful Human Computer Interface (HCl) inputs such as gesture recognition (which can be used to understand human body language), eye tracking, and brain-computer interface. These devices can be used to track personal user statistics and behaviors including what the user is looking at, the amount of time the user spends observing specific categories of items, and other data useful to training a personal doppelganger AI.

### Automatic Inputs for Model Learning

In one preferred arrangement, the AI agent may learn from one or more of the following automatic inputs. These automatic inputs may include speech input (provided by microphone 115 illustrated in FIG. 2), text input and web browsing activities (provided by GUI module illustrated in FIG. 2), facial image recognition and facial emotion detection (provided by camera 114 illustrated in FIG. 2), public data collection, location and time tracking. Several automatic inputs are summarized below.

### Speech Input

In one arrangement, the agent learns from the user's speech input to learn from the user's conversations. The agent can use speech recognition to learn from key conversations that involve thinking and decision making.

With the appropriate consent, the agent learns from how the other parties involved in the user's conversation respond to the user. This will help the agent learn from how the user responds to interactions with others. This can also help the agent train the user on how to improve their future social.

### Text Input

This is similar to speech input, in order to learn from the user's text-based conversations such as email, chat, and text messages. The agent can also learn from the users' text-based entries on websites such as filling out website forms, reviews, questionnaires, etc.

### Web and Browsing Activity

As yet another example, the AI agent may learn from which websites a user searches for and visits, and which content a user searches for on a specific site-search. This includes learning passive browsing activity on feeds such as Instagram, user hashtag preference selection, view/not-view responses to suggested content, and other available data.

### Facial Image Recognition

In one preferred arrangement, facial image recognition could be used for tracking which people the user interacts with and for how long. Facial image recognition could also be used for emotional tracking based on facial emotion detection. For example, facial emotion detection is the process of identifying human emotions from facial expressions. Emotion recognition could be used to learn about the user's emotion from video input combined with audio, and text inputs.

As just one example, facial image recognition could be useful with the psychological diagnosis's provider, and social skills trainer and advisor as herein described. Public and private facial recognition databases could be accessed in order to improve facial image recognition model accuracy.

### Public Data Collection

The individual AI model accuracy could be improved by accessing available data on the user from public, social network and data mining company databases and utilizing this data in the model. The user would have the option of setting weights on which data sources accurately describes the user, to help prevent inaccurate data reducing the model accuracy.

### Location and Time Tracking

Location and time tracking can be used to learn from the user's location and time habits. As just one example, location and time tracking may be used to track which locations a user visits, which types of locations, at what times of the day, which days of the week, and the duration. This data can help the agent learn about the effect of location and time on the user's decision making and thinking abilities as user activity can be combined with location and time activity. For example, the agent could learn that at one location type, the user tends toward reading and study, whereas at another location type, the user tends toward physical activity.

### Purchase Tracking

In addition, in one arrangement, the AI agent learns from purchase tracking to learn about the user's purchasing habits. For example, sources of inputs could include online purchases, credit/debit card purchases, and any other traceable purchases. Examples of learning include when and in what circumstances does the user make specific types of purchases and what are the purchase amounts. This can help the agent learn from the user's spending habits and provide the appropriate advice for spending. The agent could also learn from the user's spending habits based on their mood, e.g. the way the user spends when feeling negative versus when feeling positive.

### Manual Input for Model Learning

There are also one or more different types of manual inputs that can be utilized for model learning. As just one example, carefully crafted questions written and designed by members of the psychological and AI community could provide the agent with manual input in order to train the agent on the users thinking patterns and decision making with the minimal number of questions necessary. Past decisions and decision outcomes would be able to be manually inputted into the application in order to improve training accuracy. In one arrangement, the application periodically asks questions to the user about their current life circumstances and emotional well-being. For example, the application could ask the user about their overall well-being, current stress levels, and other factors that could affect the user's decision making at this present moment. Manual data inputted into wearables could also be used for training purposes.

### Data Access Design

Individual data could be stored both locally on the smart phone or client device 100 with the application and on a secure location on the cloud servers, such as cloud computing module 102 and/or distributed cloud storage 105. In one preferred agent configuration, data could be aggregated together on the cloud servers to build a combined ensemble model of all human behavior. These pooled models would in turn be accessible by the individual users over the cloud network. Data could be both processed locally on the application (for user specific data) and by dedicated cloud servers (for the aggregate data processing of all users). Cloud servers could be situated throughout the world to best service users in closest proximity to maximize data flow efficiency.

In one preferred arrangement, a large amount of storage will be required for this application. Therefore, efficient large data storage solutions, such as for the data store 109 illustrated in FIG. 2, may need to be explored. One potential solution could be the use of DNA digital data storage which has already developed momentum and has good future potential for storage in the future, if not alone, at least as a hybrid with silicon. Even if DNA does not become a ubiquitous storage material, it will almost certainly be used for generating information at entirely new scales and preserving certain types of data over the long term. This will be useful for long-term data storage use cases such as Historical Information Source and Estate Planning after Death.

### Advanced Storage Strategies for AI Data

To manage the large-scale data required for both individual and aggregated models, the AI agent may utilize the following storage solutions.

### Distributed Storage Systems

Distributed storage frameworks, such as AIStore or Hadoop Distributed File Systems (HDFS), can ensure scalability and reliability for massive datasets. These systems support real-time training and processing of AI workloads.

### Object Storage Services

Cloud-based storage solutions like Google Cloud Storage or AWS S3 can be ideal for AI applications that require storing unstructured data (e.g., speech inputs, images, and text). These services offer scalability and durability while supporting machine learning workloads. In case of on premise object storage, MinIO may be the best option.

### Data Lakehouse Architectures

A lakehouse combines features of data lakes and data warehouses, enabling efficient handling of structured and unstructured data. This architecture improves the speed of data retrieval for AI model training and analysis. This is where Dremio or Trino can be used to query data on the object storage and exposed as a REST API which can be used by the AI Doppleganger to respond to questions.

### Vector Databases

Vector databases can be essential for handling text-based information by creating embeddings of textual data. These embeddings allow the application to utilize retrieval-augmented generation (RAG) for intelligent querying and content retrieval.

### Relational Databases

Structured data, such as tabular datasets or user-specific configurations, can be efficiently stored in relational databases. These databases ensure optimal organization and retrieval of structured information that requires well-defined relationships.

By utilizing one or a combination of these data types, the system can efficiently manage diverse data sources. For instance, embeddings of text for retrieval tasks can reside in vector databases, structured data can be organized in relational databases, and unstructured content like images and videos can be stored in blob storage or S3 buckets. This integrated approach helps to ensure flexibility and performance across different AI workloads, enabling the AI agent to process and retrieve information effectively.

### Types of AI Used

Knowledge-based AI principles that could be used could include one or more of the following.
Frames
Learning by recording cases
Advanced Cased based reasoning

The decision making process according to Advanced Cased based reasoning could be as follows:
Analogical reasoning
Diagnosis

### Advanced AI Training Techniques

In one arrangement that may be utilized to improve the AI agent's ability to accurately mimic user behavior and decision-making, several advanced AI training methods can be applied.

### Transformers for Text and Speech

Transformer-based architectures, such as BERT (Bidirectional Encoder Representations from Transformers) and GPT (Generative Pre-trained Transformer), are pivotal for natural language processing (NLP) tasks. These models enable the AI agent to process complex user conversations and provide nuanced decision-making responses by extracting meaningful patterns from text and speech data.

### Convolutional Neural Networks (CNNs) for Visual Recognition

Visual inputs like facial recognition and emotion detection rely on CNNs. Frameworks such as YOLO allow the AI agent to analyze user expressions and recognize familiar individuals during interactions. This enables features like emotional context learning and personalized social coaching.

### Federated Learning for Privacy-Focused Training

Federated learning allows AI models to train on individual devices while keeping the data local. Only model updates are sent to cloud servers, ensuring user privacy. This approach reduces the need for centralized data storage and protects sensitive personal information. Tools like TensorFlow Federated are commonly used for implementing federated learning.

Transfer Learning for Mixed Traits

With transfer learning, pre-trained models are adapted to new tasks by fine-tuning specific layers, enabling the AI agent to incorporate traits from diverse behavioral patterns. For instance, models like ResNet can be fine-tuned to adapt to new visual recognition tasks with limited data. This flexibility allows the AI to adjust to the user's evolving needs and preferences without extensive retraining, providing adaptability across scenarios. For example, the AI can temporarily integrate decision-making styles from a fiscally conservative “CFO trait” model to guide spending decisions. This method reduces the need for retraining while providing flexible trait mixing for the user's preferences.

### Reinforcement Learning for Decision Models

Reinforcement learning (RL) employs reward-based optimization to refine the AI's decision-making strategies. Algorithms such as Deep Q-Networks (DQN) enable the agent to learn optimal actions through trial and error, adapting to user goals and behaviors to provide guidance in tasks like managing habits or responding to challenging situations. Tools like OpenAI Gym can be used to train the agent in providing decisions that align with user goals, such as improving financial habits or responding calmly in stressful situations.

### Synthetic Data for Training Edge Cases

In scenarios where real-world data is limited, Generative Adversarial Networks (GANs) can generate synthetic training data. For example, GANs can simulate Alzheimer's patient behavior to train the AI for memory assistance and emotional support.

### Edge AI for On-Device Training

Lightweight models (e.g., TinyML or TensorFlow Lite) can enable on-device AI

learning. This allows real-time updates for wearable devices and AR glasses without relying on cloud communication, reducing latency and improving privacy.

### Combined Ensemble Learning

Ensemble methods use multiple learning algorithms to obtain better predictive performance than could be obtained from any of the constituent learning algorithms alone. Therefore, the application could combine all of the individual models into one or more super models. A super model could provide an accurate model of overall generalized human thinking and behavior.

On the other hand, since different groups will overall think differently, it could be useful to develop additional sub combined models which could represent different groups more accurately. For example, if group A are generally greater financial risk takers, whereas group B are generally lesser financial risk takers, it would be more accurate to segment these models into groups A and B rather than average them out as an AB combined model.

Users could have the option of having his model learn from the super model or sub models from the cloud to train their individual models. They could also have the option of setting AI model weights which can be used to determine which characteristics and demographics would most influence their model. For example, the user could choose that his model be mostly influenced by the sub model for Professional North Western American males aged 40 to 50.

Additionally, they could determine the level that their model is influenced by their individual data versus the combined data from their selected models. For example, 80% of the model is learned from their personal data vs. 20% from their selected models. The possibilities for the number of user subgroups are endless. In order to address this, algorithms could be utilized which will assess similarities between subgroups, and eliminate subgroups that are too similar (below a certain threshold). It will then combine them into a larger subgroup. This would reduce the number of subgroups to a more manageable size.

### Enhancing Ensemble Learning Techniques

Ensemble learning methods like bagging, boosting, and stacking can be applied to combine multiple models for better accuracy. Specifically, the following might be used in certain AI agent arrangements.

### Stacked Generalization

Layered models allow the AI to blend predictions from smaller, specialized models into a “super model.” For example, separate models for speech input, location tracking, and financial behavior can be combined to create a unified behavioral predictor.

### Weighted Averaging

The AI agent can assign weights to models based on relevance. For instance, a financial decision might rely 80% on personal data and 20% on aggregated traits from a broader CFO demographic model.

### Subgroup Optimization with Clustering

Clustering algorithms like K-means can identify behavioral similarities across

subgroups. Instead of an overly generalized model, this approach allows the AI to fine-tune decisions based on subgroups, such as “young professionals” or “health-conscious individuals.”

### Bagging (Bootstrap Aggregating) and Boosting

Bagging improves model stability by training multiple models on different subsets of the training data. Each model's predictions are averaged to reduce overfitting and enhance accuracy. On the other hand, boosting involves training models sequentially, where each model corrects the errors of its predecessor. This method works particularly well for improving predictions on difficult or edge-case data.

### Potential Uses of Mixing AI Traits

In one preferred arrangement, the application provides the ability to modify an AI agent by combining it with other known behavioral traits with different weights. For example, this could be done for research, entertainment, or other purposes.

This could also be used to train the users on how to improve their character traits and decision making. For example, a fiscally irresponsible individual could merge fiscally conservative traits from the whole world AI (or a sub demographic such as “CFO's) into their AI agent temporarily or permanently to learn how to improve their financial decision making.

The application will have the ability to simultaneously create and maintain different versions of their base user AI with different modifications such as by adding known positive or negative character traits. This could be used for research and exploration. For example, a user would be able to create a more financially aggressive model and a more financial conservative model for decision comparison analysis between the two models. Additionally, information gained from the way users' various AI models learn and respond to their current life circumstances differently will be useful to scientists for study. For example, if an AI agent user would add a specific mental health issue to the AI agent such as Alzheimer's, how would it respond differently to your current situation?

### Enhancing AI Agents with Mixed Traits Using Transfer Learning and Fine-Tuning

AI agents can combine and integrate behavioral traits using advanced techniques such as transfer learning and fine-tuning pre-trained models. These methods allow the AI agent to adopt characteristics from specialized models, enabling a wide range of use cases:

### Transfer Learning

Transfer learning involves taking a pre-trained model that has been trained on large datasets and adapting it to perform a new, related task. For example:

If a user desires their AI agent to adopt “CFO traits,” the agent can utilize a financial decision-making model that has been pre-trained on CFO-related behaviors.

This allows the AI to adopt traits such as fiscal responsibility or risk assessment without extensive retraining.

### Fine-Tuning Pre-Trained Models

Fine-tuning involves adjusting specific weights and parameters of an existing model to align with individual user preferences.

For example, an AI agent trained for general responses can be fine-tuned to prioritize empathetic communication or emotional intelligence, improving personalized interactions.

The process requires a smaller, specialized dataset, enabling the AI to adapt quickly to individual or task-specific needs.

### Combining Traits with Decision Modules

AI agents can merge behavioral traits with decision-making modules for improved performance. For example:

Combining GPT-based language models for natural conversation with reinforcement learning modules allows the AI to engage in fluent discussions while making rational, data-driven decisions.

This blend of conversational and decision-making skills ensures that the AI reflects both the user's communication style and strategic preferences.

### Reinforcement Fine-Tuning (RFT)

Recent advancements like Reinforcement Fine-Tuning allow models to improve their reasoning abilities iteratively. This method fine-tunes the Al's decision logic based on trial-and-error learning, making it more efficient in handling complex, domain-specific tasks.

### Practical Example

In one preferred arrangement, a fiscally irresponsible user could temporarily adopt “CFO traits” by merging traits from a financial decision-making model into their AI agent. Simultaneously, fine-tuning the AI to focus on the user's emotional patterns could ensure the decisions remain aligned with their broader goals.

### Considerations for Implementation

Data Requirements: Ensuring access to relevant and high-quality datasets to accurately reflect the traits being integrated.

Computational Efficiency: While transfer learning reduces the need for retraining, fine-tuning requires adequate infrastructure for smooth performance.

Ethical Implications: Careful monitoring is required to prevent unintended biases and ensure the AI traits align with user intentions.

### Manual AI Agent Combinations into Groups

Users will have the option to combine their AI agent with other users' agents with consent to make a combined agent copy. This could be useful for various reasons such as speculating what character traits and personality a child between two users would exhibit. Alternatively, complex AI agent combinations could be created to form manual group AI agents. This could be useful for a variety of purposes such social, economic and political experiments, for research and exploration, and for creating specialized AI agent combinations. For example, the formation of a combined successful Chief Financial Officer group might be very advantageous for making successful financial decisions. Combining a successful psychologist AI might be very advantageous for psychological counseling.

### AI Agent Combinations: Proposed Approach

To develop AI agent combinations, where user models can merge into group-based agents for research, decision-making, or simulation, we need an approach leveraging ensemble learning, federated data modeling, and modular AI frameworks. This will allow us to maintain flexibility, scalability, and ethical boundaries in combining multiple AI agents.

### Individual AI Agent Creation

In one preferred arrangement, each user's AI doppelgänger is trained individually through user behavior data, manual inputs, and aggregated data. This creates a modular agent tailored specifically to the user. Multiple user AI agents can then be integrated into a super-agent using ensemble learning techniques. Methods like bagging, boosting, and stacking, such as Random Forest or Gradient Boosting models, can aggregate predictions from individual agents into a unified output. Group-based combinations are achieved hierarchically, where agents with shared behavioral patterns align into sub-models. Algorithms like K-Means or DBSCAN measure these similarities to cluster agents effectively.

### Federated Learning for Security

Combined agents can be securely trained using federated learning. This approach ensures that data remains decentralized on user devices, while only learned model weights are shared to build the group agent. Federated frameworks, such as Google's TensorFlow Federated or PySyft, enable this process and ensure privacy and security throughout.

### APIs and AI Frameworks

To achieve practical AI agent combinations, existing APIs and pre-trained AI frameworks can be used. TensorFlow and PyTorch can help build modular deep learning models, while federated AI libraries such as TensorFlow Federated or OpenFL allow decentralized model training. Graph Neural Networks (GNNs) can simulate relationships between individual AI agents, enabling group decision-making. GPT-like language models can further simulate dynamic behaviors of agents by assigning specific traits and weights, such as merging traits of a Chief Financial Officer into a user agent for financial decision-making.

### Methods for Agent Merging

AI agent traits can be merged through linear weight adjustments, where individual agent attributes are combined in proportion. For example, combined traits can be expressed as a weighted sum like (0.6 * User_Agent)+(0.4 * CFO_Agent). Reinforcement Learning (RL) can also be used to fine-tune group agents for optimized performance in specific tasks. RL frameworks like OpenAI Gym provide environments for simulations and experiments to achieve this.

### Practical Use Cases

AI agent combinations offer several practical use cases. In financial decision simulations, agents of successful CFOs can be combined to predict better financial strategies. In psychological counseling, agents of experienced psychologists can be merged to create a specialized group counselor. Social experiments can also benefit from combining agents of diverse demographic backgrounds to simulate interactions or predict societal trends.

### Challenges and Security Considerations

Developing AI agent combinations also comes with challenges and security considerations. Federated learning helps preserve user privacy by keeping data encrypted and decentralized. Data biases can be addressed using clustering techniques and anomaly detection to ensure fairness across group agents. A modular framework that includes cloud-based ensemble aggregation allows the system to scale efficiently as the number of users grows.

### Potential Use Cases

### Personal Assistant and Communications Response Agent

The agent could respond to simple phone calls with appropriate voice responses with a cloned version of the user's voice. In one preferred arrangement, the agent would learn this from the user's voice input. The agent could also respond to text messages and emails with their appropriate text responses as if it were the actual user responding. This will seem very lifelike to the phone call recipient as the responses would be highly similar to the user in content and style. Ideally the phone call recipient will not be able to distinguish between the agent and the actual user and will think that it is the actual user that he or she is interacting with.

The AI agent may also be configured so that the agent will be able to make basic minor decisions for the user and respond accordingly, based on past user decisions and preferences. For example, if the dry-cleaning company calls and asks about when he would like the delivery, he would respond Monday after 6 pm.

Additionally, the assistant could be instructed to make a phone call to the local Pizza delivery and make the appropriate phone request.

Another useful agent function would be for the agent to respond to emotionally distressing negative content directed at the user on social media, reviews, and emails, etc. This would spare the user of experiencing these negative emotions from viewing and responding to this negative content and instead allow for levelheaded and appropriate responses.

### Health Monitor and Feedback Provider

The agent could monitor different user inputs and provide the appropriate health feedbacks and warnings. For example, sudden impaired decision making could indicate a certain health condition and alert the user and provide appropriate health advice on how to improve the condition.

### Life Span Predictor

The agent could provide a current life span estimate based on the user's behaviors, decision making habits, and changes to behavior and decision making. The estimate would be learned from the general models from all pooled users who have passed away from natural causes. This could include providing daily, weekly or other interim charts and graphs similar to current exercise trackers, by gauging and displaying to the user the user's probable lifespan based on short and long term behavior.

### Data Collection

The Health Monitor and Feedback Provider can leverage wearable devices (e.g., fitness trackers, smartwatches) to collect vital health data like heart rate, activity levels, and sleep patterns. AI/ML

AI models such as RNNs or LSTMs can analyze this data for anomalies and predict potential health issues, offering timely alerts and actionable feedback. Integration with time and location tracking can provide context-sensitive insights, such as identifying environmental stressors affecting the user's health. Federated learning ensures privacy by processing sensitive health data locally while enabling global model updates.

### Reporting

Real-time notifications can be delivered via mobile apps to guide users on improving health, such as hydration or stress reduction tips. The system can connect with existing health ecosystems like Apple HealthKit or Google Fit to expand data sources and enhance user engagement.

### Psychological Diagnoses Provider and Therapy Coach

The agent could help diagnose a person with psychological challenges and aid the user with strategies and solutions on how to best cope with and manage them. For example, certain negative decision making and behavior patterns may indicate certain psychological conditions.

The agent could then assess the outcome and effectiveness of applying different coping strategies to the user and use this information in order to subsequently offer only strategies that are effective. The agent can therefore serve as a therapy coach helping the user improve on and overcome psychological issues.

### Data Collection

In one arrangement, the agent can monitor communication patterns (e.g., tone, word choice) and behavior trends from text, voice, and interaction data to detect signs of psychological challenges. Self-reported surveys and mood trackers can be integrated into the system for periodic assessments.

### AI/ML

Advanced NLP models, such as transformer-based architectures (e.g., GPT or ROBERTa), can analyze text for sentiment and mental health markers. Reinforcement learning can be employed to iteratively refine coping strategies based on user feedback and outcomes.

### Personalized Strategies

The agent can offer actionable strategies tailored to the user's needs, such as mindfulness exercises, stress management techniques, or journaling prompts. It can adapt suggestions dynamically based on real-time feedback, emphasizing approaches that have proven effective for the individual.

### Outcome Assessment

Progress reports can be generated to evaluate the user's improvements over time, including emotional stability, stress levels, and decision-making patterns.

### Privacy

Data privacy and security must be ensured through robust encryption and compliance with health data regulations (e.g., HIPAA). Explicit user consent should be required for any data collection or sharing.

### Decision Making Aid

The agent could learn from past decision making and outcome in order to best inform the agent's user of current decisions that you need to make. For example, the agent's user could ask it: “What would you do in this given situation?” The agent would respond with the best possible decisions and provide the decision rationales based on past similar outcomes.

### Data Collection

The agent can gather data from past user decisions, including choices made in communication, financial transactions, scheduling, and other tracked behaviors. Contextual metadata, such as time, location, and emotional state during decisions, can enhance understanding of decision patterns.

### AI/ML

Reinforcement learning can be applied to analyze the outcomes of past decisions and optimize future suggestions by maximizing positive results. Case-based reasoning systems can identify patterns in decision-making, while explainable AI models can provide rationales for suggestions.

### User Interaction

The agent can present decision suggestions through a conversational interface, allowing users to query options in specific scenarios. The interface can display the rationale behind each recommendation, including factors like past success rates and potential risks.

### Feedback Loop

The system can continuously refine its suggestions based on real-time user feedback and new decision outcomes, creating a personalized and evolving decision aid. Users can explicitly rate the helpfulness of decisions or allow the agent to track indirect feedback through observed outcomes.

### Privacy and Trust

Secure data storage and processing are critical to protect sensitive decision-making history. Ethical considerations, such as avoiding undue influence and ensuring user autonomy, must guide the system's design.

### Spending Habit Tracker and Advisor

The agent could track user's spending and offer advice and warnings before negative purchases (such as expensive and wasteful) are about to be made, based on past performance. The agent could also provide relevant info on how to improve spending habits.

### Personal Progress Reporter

The agent could provide reports and updates on how well the user is performing in his or her life and decision making compared to earlier time periods. In one preferred arrangement, a progress report could be integrated with the agent's other use cases to provide updates on progress on the patient's health, psychological well-being, decision making, social skills and interactions, and spending habits, etc.

### Job Matcher

The agent could match up the user to potential available jobs and job types based on the user's thinking and decision styles, personal habits, and attributes.

### Relationship Match Maker

The agent could match up the user to potential available matches for relationships based on compatible ways of thinking, goals, etc.

### Historical Information Source

The agent could be used beyond the user's life by family members, historians and scientists in order to understand how a person lived and their thinking and decision-making processes.

### Data Collection

The agent can archive a comprehensive record of user interactions, decisions, and contextual data (e.g., communications, preferences, and daily activities) throughout the user's lifetime. Advanced storage solutions like distributed systems or emerging technologies such as DNA data storage can ensure scalability and long-term accessibility of the data.

### AI/ML

NLP models can analyze text-based data for themes, while reinforcement learning can identify meaningful insights from decision outcomes over time.

### Presentation

The data can be presented in a timeline format, enriched with multimedia elements such as audio recordings, written notes, and visual memories (e.g., photos or videos). Interactive queries can allow historians or family members to explore specific aspects of the user's life, such as responses to significant historical events or daily habits.

### Applications

For family members, the agent could serve as a digital memoir, preserving personal stories and values. For historians and scientists, it can provide unique insights into individual and societal behavior patterns, aiding studies in sociology, psychology, and history.

### Estate Planning After Death

The agent would provide the best-informed decisions that the deceased user would have made regarding estate planning.

### Rapid Decision Environment Representative

Personal AI doppelgangers could represent the user in gaming and other high-speed

environments, particularly in rapid decision environments where AI agents have a speed advantage over humans. For example, the agent could be used for high-speed stock trading to carry out trades based on the user's trading preferences.

In high stress circumstances, when the user is subjected to stresses such as social, financial, physical threat, emotional threat, etc., it may take the user some time to absorb the situation and think clearly about how to respond.

In such situations, the agent can be used to help the user by informing the user that the user is in a high-stress situation (by monitoring the emotional state of the user, or recognizing the situation as high stress). The agent can then rapidly provide a clear, rational perspective of the situation to the user, aiding the user in clearly understanding the situation and provide direction and instructions on how the user could best respond to the situation. Best responses could be learned from both the user's and the other users' successful responses to similar situations combined with publicly available best practices data.

An example of the agent's usefulness would be if the user is confronted with an active shooter. Without the help of the agent, the user could freeze and not know how to respond in time and thereby be in danger. To prevent this, the agent could rapidly provide the user direction for best practices and guide the user to safety. Additionally, the agent could have real-time access data relevant to the situation such as police report updates and social media data.

### Difficult Circumstances Response Predictor

The user could introduce potentially stressful circumstances and experiences to the AI agent and study the AI agent's projected response and long-term impact from the circumstance and experience. For example, if the agent just won the lottery, how does it react emotionally and how does this affect its future life decisions. This could be very useful the user in predicting how the user would respond to certain future circumstances that he might be facing.

### Pre-Screener and Relevance Sorter

The agent could be used for daily activities such as pre-screening and sorting data at a much more rapid pace than humans. For example, the agent could rapidly sort through Google search results and provide the search results in the descending order of most relevance to the user, based on the user's behavior and preferences. This could improve on Google's relevance sorter as the agent would have much more information on the user's thinking and preference.

### Journal Scribe

Since many people find it difficult to write a daily journal, the personal AI agent could write a diary for the agent user by documenting the user's daily experiences in the user's own personal writing style.

### Media Playlist Creator

The personal AI agent can be utilized to rapidly create comprehensive music, video and other types of media or reading material lists based on its holistic knowledge of the user's tastes and preferences. These lists could be more accurate and relevant than current methods used which are solely based on the user's prior media selections and on other users' media selections.

### Real-Time Language and Cultural Translator

A potentially powerful use would be to enable peoples of different languages and

cultural backgrounds to communicate in real-time and clearly understand each other. The app could translate the communication from a user from one language and culture to a user from another language and culture including the specific regional, demographic and cultural differences and nuances in the translation.

This could potentially be achieved by utilizing combined AI agents for each language, culture, and demographic and enabling translation from one combined agent to another. This would likely need to be combined with utilizing large amounts data which accurately describes language and communication from each culture. Methods would need to be developed to normalize the data among different cultural databases to enable accurate translations. Additionally, a large amount of manual training and testing in the translations would be required.

The AI agents of users who have the ability to successfully communicate with multiple languages and cultures could be used to automatically train these translations.

### Achieving Real-Time Language and Cultural Translation

Real-time language translation involves the immediate conversion of spoken or written language while preserving cultural nuances and accuracy. This can be achieved using advanced AI techniques and tools as noted below.

### Neural Machine Translation (NMT) Models

Modern translation relies on Transformer-based NMT models, such as Google's Seq2Seq and OpenAI's GPT architecture. These models process entire sentences, allowing them to understand context and generate coherent, accurate translations. For example, Google Translate uses Transformers to handle translations across 100+languages while retaining fluency.

### Integration of Cultural Datasets

Incorporating culturally specific datasets improves translation quality by capturing idioms, regional dialects, and context-specific phrases. By analyzing cultural data, the AI agent can ensure that translations are not only correct but also culturally appropriate.

### Low-Latency AI Inference Engines

Achieving real-time translation requires low-latency processing. AI inference engines such as ONNX Runtime and NVIDIA TensorRT optimize neural network performance, enabling rapid language processing without delays. These tools ensure the translation engine works seamlessly for live interactions, such as video calls or augmented reality scenarios.

### Transfer Learning for Multilingual Capabilities

Transfer learning allows models trained on resource-rich languages (like English) to adapt to low-resource languages and regional dialects. This method minimizes training time while improving accuracy across diverse linguistic variations.

### Scalability for Multi-Language Databases

To support multiple languages, the system must utilize efficient data storage structures. For example: A scalable database can store translations in separate language tables or columns, enabling easy retrieval and updates as new languages are added. This ensures the system can accommodate global users without compromising performance.

### Example Use Case

Imagine a user communicating with a client in Japan. The AI agent processes their conversation in real-time, translating English to Japanese while adjusting for cultural nuances like honorifics. Using low-latency engines, the translations are instant, enabling smooth and context-aware communication.

### Social Skills Trainer

Social skills training will be based on what social skills the user needs to improve

on based on their own interactions with others and also with the pooled data from all users who have had negative responses in their social interactions.

For example, if the pooled agent learns that users with aggressive tones experience negative social responses, the agent can be used to provide training courses and/or content tailored to the user on how to interact in a less aggressive manner.

### Social Skills Advisor

In one preferred arrangement, the agent will be used to provide social skills advice based on past interactions with other people. For example, since different people require different types of social interactions, the social skills advisor will recognize and record and learn from interactions with specific people and provide the appropriate advice on how to interact with them specifically. For example, based on past experiences of the user's interactions with John, the agent learned that communicating in a tough and firm manner produced negative results. The advisor would then advise the user to soften his future interactions with John and would provide real-time alerts and reminders if the user begins to use tough and firm interactions again with John.

It is believed that this approach might work best with interactions with people that the user has interacted with in the past. Appropriate interactions with new people might require a different approach. There would be a difficult method of interaction based on the user's best style with new people with no prior known knowledge about them. One approach could be to gain knowledge based on facial recognition of approximate age and sex. The agent could learn group-based interactions from prior experiences. For example, the agent could have a general form of interacting with members of the young male's group, vs. middle aged females vs. elderly males, etc.

### Benefits to Alzheimer's and Dementia Patients

“Alzheimer's is a type of dementia that affects memory, thinking and behavior. Symptoms eventually grow severe enough to interfere with daily tasks. Alzheimer's worsens over time. Alzheimer's is a progressive disease, where dementia symptoms gradually worsen over several years. In its early stages, memory loss is mild, but with late-stage Alzheimer's, individuals lose the ability to carry on a conversation and respond to their environment.

The presently disclosed AI agent could be of benefit to these patients by making use of many of the agent's use cases as described herein. For example, the AI agent could use the Social Skills Advisor to help the user carry on a conversation and respond to their environment in a similar fashion to the way they communicated before onset of Alzheimer's symptoms. This could be achieved by coaching the user on how to respond to this particular person based on past experiences, or in more extreme Alzheimer's cases, the agent would have to respond and communicate to the other person directly in place of the user.

The Personal assistant and communications response agent could respond to easy requests on behalf of the user. The most common early symptom of Alzheimer's is difficulty remembering newly learned information because Alzheimer's changes typically begin in the part of the brain that affects learning. In such a case where the user is having difficulty learning new information, the AI agent could take the place of the user and learn on behalf of the user and provide the relevant information to the user real-time for the current circumstances.

As Alzheimer's advances through the brain it leads to increasingly severe symptoms, including disorientation, mood and behavior changes; deepening confusion about events, time and place; unfounded suspicions about family, friends and professional caregivers; more serious memory loss and behavior changes; and difficulty speaking, swallowing and walking. Deepening confusion about events could be aided by the AI agent such as with the Rapid Decision Environment Representative: The agent will rapidly provide a clear, rational perspective of the situation to the user, aiding the user in clearly understanding the situation and provide direction and instructions on how the user could best respond to the situation. Confusion about events, time and place could be aided by the app's Location and Time Tracking feature. The app could inform the user about how often the user is in this location and remind him of what his normal activities are in this location and during these times, and what his association is to this place.

Unfounded suspicions about family, friends and professional caregivers could be aided by the AI agent explaining to the user who the person they are speaking to is, and how long they've known and trusted them, etc. If necessary, the app could provide relationship evidence such as video recordings of their relationship and significant past pictures together. Relationship identity data could be provided from social network data or if not available, from the facial image recognition inputs time tracking. Dementia describes a group of symptoms associated with a decline in memory, reasoning or other thinking skills.

Disorders grouped under the general term “dementia” are caused by abnormal brain changes. These changes trigger a decline in thinking skills, also known as cognitive abilities, severe enough to impair daily life and independent function. They also affect behavior, feelings and relationships.

The agent can aid the user with a decline in thinking skills by using the users past successful thinking patterns and skills to coach the user into correctly assessing the situation and making the correct current decision. The user could also benefit from the features of the Rapid Decision Environment Representative.

The Health monitor and feedback provider could identity patterns or changes to thinking and memory in order to help diagnose Alzheimer's and Dementia.

### AI-Powered Interventions for Alzheimer's and Cognitive Decline

Artificial intelligence (AI) offers innovative solutions to support individuals experiencing memory loss and cognitive decline associated with Alzheimer's disease and other forms of dementia. Key AI-driven interventions include the following.

### Cognitive Reinforcement Using Recurrent Neural Networks (RNNs)

Long Short-Term Memory (LSTM) Networks: These advanced RNNs can model sequential data, making them suitable for developing applications that reinforce cognitive functions. For instance, AI companions utilizing LSTM networks can engage users in personalized storytelling, aiding memory recollection and boosting confidence.

### Real-Time Reminders with Context-Aware Tracking

Location and Context Awareness: AI systems can provide timely reminders by integrating contextual information such as location and time. This approach ensures that prompts are relevant and supportive, assisting individuals in daily activities and enhancing their autonomy.

### Speech Coaching Using Emotion-Aware Response Modules

Emotion Recognition: AI-driven speech analysis can detect emotional cues, enabling responsive interactions that adapt to the user's emotional state. Such systems can offer supportive communication strategies, improving engagement and emotional well-being.

### AI-Based Detection of Cognitive Decline

EEG Monitoring with Machine Learning: Combining electroencephalogram (EEG) data with machine learning algorithms allows for the early detection of cognitive decline. AI enhances the analysis of EEG tests, enabling neurologists to identify early signs of dementia more quickly and precisely.

### Future Potential Use Cases

It has been contemplated that at some point in the future, human-computer mind transfer will be possible. This involves a human mind being copied and then uploaded into a robot or AI agent. The feasibility of this in the near future is questionable. However, perhaps training our AI agent over the span of a human lifetime would provide a feasible method to eventually lead to developing a highly accurate mind model.

A near term potential use could be to use the AI agent to remotely control robotic equipment which would enable many types of autonomous communication and work to be performed. This included computer to brain interfaces like nurolink and other computer to body interfaces that would benefit from the rapid interpretation and response of a digital copy of the human.

In one preferred arrangement, the AI agent would be trained by use of robotic avatars. Avatars are generally a digital form of a user that they inhabit and use in different digital situations. This can now be extended to an avatar having a physical aspect to it in the form of a robot. A person could inhabit a robotic body, control it, and experience what the robot would be experiencing.

Over time as the user controls the robotic avatar, the AI agent could be trained to control the robot with increasing levels of autonomy with less user input required. Eventually, with sufficient training, the agent could control the robot completely autonomously.

This method takes advantage of utilizing human computer interfaces in order to transition from the human brain to computer interface.

### Advancements in Brain-Computer Interfaces (BCI)

Brain-computer interfaces (BCIs) have made rapid advancements, enabling direct communication between the human brain and external systems. Technologies such as Neuralink have shown promising results in interpreting neural signals and allowing users to control digital devices with their thoughts. For example, recent trials demonstrated individuals with paralysis successfully operating computer cursors and robotic arms using only neural implants.

### Enhancing Human-Computer Communication

The AI Doppelgänger can leverage BCI technology to significantly improve the speed and precision of human-computer communication. By directly interpreting neural signals, the AI eliminates the need for traditional input devices like keyboards or touchscreens. This provides a seamless communication pathway, particularly benefiting individuals with mobility impairments or cognitive challenges.

### Controlling Robotic Avatars Using Reinforcement Learning

BCIs, when combined with reinforcement learning (RL), enable users to control robotic avatars using thought-based inputs. Reinforcement learning algorithms allow the AI Doppelgänger to adapt to the user's unique neural patterns over time, improving the responsiveness and accuracy of robotic control. For example:

The AI can help train robotic arms or avatars to perform complex tasks (e.g., physical movements or object manipulation).

The RL system continuously learns from user feedback, refining its performance for smoother and more natural control.

This integration is particularly beneficial for applications such as remote robotics, assistive technologies for individuals with disabilities, and immersive virtual reality environments.

### High-Speed AI Feedback for Language and Gesture Translation

High-speed AI feedback loops allow the AI Doppelgänger to process neural signals in real-time for translating intended speech and gestures. By analyzing neural activity:

The AI can convert the user's thoughts into real-time language output, enabling seamless communication across language barriers.

Gestures or physical motions can also be interpreted and translated into corresponding robotic actions.

This capability can facilitate cross-cultural communication, real-time language translation, and enhanced human-robot interactions, making the AI Doppelgänger a versatile interface between humans and machines.

### Privacy and Consent Considerations

Identifiable individual data will only be accessible by the user. Pooled data would be de-identified for privacy. The user shall have sole ownership over the user's individual AI model which will be securely accessed and utilized solely by the user.

The user will have the ability to grant various data sharing permissions to specific users and at specific times. For example, the user will be able to set if his model will be publicly available and if so, at which dates and times. Additionally, the user could set user availability criteria rules such as only making the data available to extended family members, or other users who are similar in personality, demographics, social circumstances, political views, etc.

The user will set permissions to allow their AI model to be combined with other users' AI models and be used only for specific purposes. For example, the model could be set to be publicly available for game theory research but not stock market predictions. The stock market prediction or other specific data could be set to be shared with specific users only such as family or board members. Learning from text based input and voice based input from the other parties involved would require prior consent from the other parties.

### Security

Since the personal agent data would be extremely important to protect and maintain privacy, we would need to build into the agent several security measures and safeguards. Additionally, the learned AI agent models themselves are valuable intellectual property that requires protection. The agent models pose a risk of being misused by malicious users. For example, the malicious user could try to predict how the user would act and make decisions and use this knowledge against the user for various malicious purposes. Security will need to be incorporated throughout the entire product lifecycle. Security will be needed to protect all phases of the app operation such as during power up, at runtime and while offline.

### Implementing Advanced Security Measures

### Zero Trust Architecture with End-to-End Encryption

Zero Trust Model: This security framework operates on the principle of “never trust, always verify,” requiring strict identity verification for every person and device attempting to access resources, regardless of their location within or outside the network.

End-to-End Encryption: Implementing end-to-end encryption ensures that data remains encrypted throughout its entire journey—from the source to the destination—protecting it from interception or unauthorized access during transmission.

### Homomorphic Encryption for Secure Cloud Operations

Homomorphic Encryption (HE): HE allows computations to be performed directly on encrypted data without the need to decrypt it first, preserving data privacy during processing. This is particularly beneficial for cloud operations, enabling secure data analysis and processing in untrusted environments.

### Enhanced “Kill Switch” Logic with AI Anomaly Detection

AI-Powered Anomaly Detection: Integrating artificial intelligence to monitor system behavior can help identify unusual patterns indicative of security threats. When such anomalies are detected, the system can trigger a “kill switch” to halt operations, preventing potential breaches or mitigating ongoing attacks.

### Secure Federated Learning for Privacy-Preserving Model Training

Federated Learning: This machine learning approach enables the training of models across multiple decentralized devices holding local data samples, without exchanging the data itself.

Privacy Preservation: By keeping data localized and only sharing model updates, federated learning enhances privacy. Combining this with homomorphic encryption further secures the process, ensuring that even the shared model updates remain confidential.

### Secure Booting

Secure booting will establish integrity which will ensure that the app is performing its intended function and has not been altered by a hacker. This could be achieved by using cryptographic signatures on the firmware to determine authenticity.

### Secure Updates

Since the AI agent models and data will need to be updated continuously, end-to-end security will be required to protect the process of distributing the updated models. Additionally, the AI app will be needed to be updated in a secure way to fix security vulnerabilities, bugs, and provide improvements.

### Authentication and Authorization

A malicious hacker might want to tamper with the user's AI model so that the app will give the user poor decision advice, respond inappropriately to emails, give bad coaching, etc. Therefore, use of authentication and authorization is necessary to prevent this from happening.

Transport layer security (TLS) will provide authentication and identification in order to ensure that only secure and authenticated data flows between the app and its servers. It will provide privacy and data integrity and prevent eavesdropping and tampering. TLS his will prevent the inputs to the AI model from being altered and thereby the model itself from being tampered with. A hardware root of trust can ensure the security of credentials used to complete identification and authentication, as well as the confidentiality and authenticity of the data itself.

Additionally, we would need to use the appropriate authorization mechanisms in order that only authorized users can access the app and the information provided from the app.

This could be provided by third party or two-factor authentication (2FA) requesting extra information such as answers to secret questions, requiring the possession of a small hardware token, or using Biometric Authentication using the following technologies: retina scans, finger scanning, facial recognition, and/or voice identification.

### Encryption

The personal agent data and models would need to be encrypted so that it is not accessible by hackers and unauthorized users. At the same time it will need to be accessible by the app and the cloud servers responsible for creating and maintaining the combined ensemble models.

The large data sets will need to be protected in memory such as DRAM, or on the hard disks. The authentication and encryption can be backed by strong key management systems enabled by hardware root of trust.

One potentially useful encryption type to use would be Homomorphic Encryption (HE) which is an effective way to help protect data privacy when using cloud computing and AI. HE technology allows computations to be performed directly on encrypted data. Using state-of-the-art cryptology, the app can run machine learning and AI algorithms on anonymized datasets without losing context. Authentication or securing the password for decryption should be best practices like but not limited to one way hash.

### Kill Switch

The agent will have a mechanism by where it scans online for information that indicates that it has been reported stolen or compromised and the agent will subsequently lock down at that time until reactivation by the user.

Additionally, the user can manually enable the kill switch if the agent begins to behave inappropriately.

### Automated Monitoring

The agent can use AI-powered anomaly detection to continuously monitor online activity and internal system behavior for signs of compromise, such as unauthorized access attempts, unusual data patterns, or public reports of a data breach.

### Kill Switch Activation

When a compromise is detected, the agent automatically enters a lockdown state,

disabling all sensitive operations and data access until reactivation by the verified user. The user can also manually trigger the kill switch via the app, using a simple and secure interface.

### User Reactivation Process

Reactivation can involve multi-factor authentication, such as biometric verification, secure passwords, or one-time passcodes sent to trusted devices. This ensures only authorized users can regain control.

### Technology Stack

Secure Boot ensures the system integrity during restarts after a lockdown. Homomorphic encryption can preserve the integrity of encrypted data during compromised states, while Transport Layer Security (TLS) protects real-time communications.

### Data Correction

The agent will make use of data dorrection, which is the activity of checking data whether it is correct or erroneous, or to make a corrected for further use. It can make use of AI and ML algorithms to automatically and predictively detect data errors when and where they occur and automatically correct them before they are used such as with Rulex's Robotic Data Correction software.

### Self Correcting Algorithms

A sufficiently developed AI agent's security would include self-correcting algorithms. These would involve a frequent review of current code against previous code in order to determine:

1. Data degradation caused by hardware storage failures, storage limits, degradation from malicious software such as viruses, worms, or Trojans or other potentially unknown causes. Error-correcting code (ECC) memory could be used to detect and correct data corruption.

Unusual user training input to determine if there is a major change in user behavior. This could be achieved with intrusion detection type ML algorithms. This could help detect unauthorized inputs to the agent.

Outside code influences including viruses and direct assault. I suspect the agent would need a minimum of three concurrent iterations to apply self correcting code real-time.

### Potential Issues and Solutions

If the agent responds inappropriately

The AI agent will be alerted to inappropriate responses or decisions based on negative feedback from the other parties the agent is interacting with. For example, if the other parties respond with a confused or negative tone, the agent will tag this interaction as negative and immediately alert the user on how to proceed. If the user is unavailable, it will either respond with the next best response or decision available to the agent, or if none is available, with an “I don't know” response.

The negative interaction tag will train the agent to no longer use this interaction. Additionally, the user will provide manual feedback to the agent regarding its responses which will train the agent to adjust its model accordingly for future responses. As a safeguard, if the agent responds inappropriately too many times beyond a certain threshold, then the agent will be automatically trained to not proceed without the user first providing input.

If the agent makes incorrect or inappropriate decisions

The agent will utilize reinforcement learning algorithms to evaluate decision outcomes. Reinforcement learning (RL) is an area of machine learning concerned with how software agents should take actions in an environment to maximize the notion of cumulative reward. Positive decision outcomes can train the agent to use these decisions more often in the future, and negative decision outcomes will train the agent to use these decisions less often in the future

If the agent doesn't have sufficient information to know how to decide or respond

The agent will not proceed until the user gives the agent appropriate input for a correct response. If the user is unavailable at the moment to provide the input, the agent will give a response such as “I don't know at the moment, please let me get back to you.”

### Legal Responsibility for the Agent's Decisions and Responses

Decisions will need to be made whether the user or the company which developed the agent would be responsible for the agent's decisions. A waiver would need to be signed to absolve the company of responsibility in the event that decisions with negative outcomes were made by the agent.

### Personal and Other Data Monitoring

Since the trained AI agent knows more about the user than any other source, it can actively monitor the internet and other data sources to identify any personally identifiable data, or any data mimicking the doppelganger. The AI agent could then take rapid pre-agreed action against the data breach threat.

### Data Monitoring

The AI doppelganger can use web scraping and API integrations to continuously scan the internet, social media, and data repositories for occurrences of personally identifiable information (PII) or data resembling the user's behavior, decisions, or content. Tools like Selenium or BeautifulSoup can facilitate real-time monitoring, while Natural Language Processing (NLP) models can assess the relevance of detected data.

### Threat Detection

AI anomaly detection models can flag unusual activities, such as data breaches, impersonation attempts, or unauthorized uses of the user's likeness or behavioral patterns. Pre-trained models for PII detection (e.g., name, address, or biometric data) can enhance monitoring efficiency.

### Pre-Agreed Actions

Upon identifying a threat, the AI can take automated actions such as filing takedown requests, notifying the user of the breach, or initiating communication with relevant authorities. Users can define these actions in advance based on their preferences and the sensitivity of the data.

### User Interaction

The agent can notify users through mobile or desktop alerts about detected threats, providing summaries and suggested next steps. A dashboard could display ongoing monitoring status and allow users to refine monitoring preferences.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described to best explain the principles of the embodiments, the practical application, and to enable others of ordinary skill in the art to understand the disclosure for various embodiments with various modifications as are suited to the particular use contemplated.

I claim:

1. An artificial intelligence (AI) agent, said agent comprising:
a computing device comprising at least one processor, said at least one processor programmed with computer program instructions that, when executed by said processor, the computer program instructions program said computing device to:
monitor a first user behavior;
monitor the first user input;
aggregate data from users other than the first user; and
utilize Artificial Intelligence (AI) to continuously learn from user behavior, user input, and aggregated data from other users other than the first user.

2. The AI agent of claim 1, wherein the computing device comprises a smart phone.

3. The AI agent of claim 1, wherein the computing program instructions comprise a mobile application.

4. The AI agent of claim 1, wherein the computing device comprises a wearable technology.

5. The AI agent of claim 4, wherein the wearable technology comprises a fitness tracker.

6. The AI agent of claim 4, wherein the wearable technology comprises a biologic sensor.

7. The AI agent of claim 1, wherein the wearable technology provides at least one human computer interface input.

8. The AI agent of claim 7, wherein the at least one human computer interface input comprises a gesture recognition.

9. The AI agent of claim 1, wherein the computer device is programmed to track personal user statistics.

10. The AI agent of claim 1, wherein the computer device is programmed to track a personal behavior.

11. The AI agent of claim 1, wherein the AI continuously learns from user input, such as an automatic input.

12. The AI agent of claim 11, wherein the automatic input is selected from the group of speech input, text input, web browsing activities, facial image recognition, facial emotion detection, public data collection, purchase tracking, location and time tracking.

13. The AI agent of claim 1, wherein the AI continuously learns from user input, such as manual input.

14. The AI agent of claim 13, wherein the manual input comprises at least one written question.

15. The AI agent of claim 1, wherein data is stored on the computing device.

16. The AI agent of claim 1, wherein data is stored on a remote secured location.

17. The AI agent of claim 16, wherein the remote secured location comprises a cloud server.

18. The AI agent of claim 1, wherein the AI comprises a knowledge-based AI.

19. The AI agent of claim 1, wherein when executed by said processor, the computer program instructions program said computing device to modify the AI agent by combining it with other known behavioral traits with different weights.

20. The Al agent of claim 1, wherein when executed by said processor, the computer program instructions program said computing device to combine the AI agent with other users' agents with consent to make a combined agent copy.
